(19) United States
(12) Patent Application Publication
(10) Pub. No.: US 2021/0094094 A1
(43) Pub. Date: Apr. 1, 2021

(54) COMPOSITE PART AND METHOD AND TOOLING FOR MAKING THE SAME

(71) Applicant: Grouper Casting, LLC, Lexington, KY (US)

(72) Inventors: Alexandre Reikher, Pleasanton, CA (US); Sam Kassoumeh, Canton, MI (US)

(21) Appl. No.: 16/607,928

(22) PCT Filed: Jun. 6, 2018
(86) PCT No.: PCT/US2018/036259

§ 371 Date: Oct. 24, 2019

Related U.S. Application Data
(60) Provisional application No. 62/515,589, filed on Jun. 6, 2017.

(51) Int. Cl. B22D 19/08; B22D 17/22; B22D 19/14; B22D 21/04; C22C 1/10; F16D 65/12; F16D 69/02

(52) U.S. Cl. CPC B22D 19/08; B22D 17/22; B22D 19/14; B22D 21/04; C22C 1/1036; F16D 2250/0007; F16D 65/127; F16D 69/027; F16D 2200/003; F16D 2200/0065; F16D 65/125

(57) ABSTRACT

Composite parts (10), methods of making the same (400), and tooling systems (200) for making the same are disclosed. According to one example, a high-pressure die casting process is used to manufacture a composite part (10) that is made from a composite metal material (12) with a metal matrix phase (20) and a particle phase (22) and includes an interior region (14) and an exterior region (16), where an average concentration of the particle phase (22) in the composite metal material (12) is higher in the exterior region (16) than in the interior region (14). An interior surface (206a, 206b) of a die mold (206) may be coated with a particle phase (22) (e.g., a ceramic-based material) and a molten metal matrix phase (20) (e.g., an aluminum-based material) may then be introduced into the die mold (206) such that a composite part (10) is formed with an exterior region (16) or outer layer that is particle-rich compared to an interior region (14).

### CROSS-REFERENCE TO RELATED APPLICATIONS

This application claims priority to U.S. Provisional Patent Application Ser. No. 62/515,589, filed on Jun. 6, 2017, the contents of which are hereby expressly incorporated by reference in their entirety.

### FIELD

The present disclosure relates to composite parts and, more particularly, to composite parts that are made from a composite metal material having a metal matrix phase and a particle phase using a high-pressure die casting process.

### BACKGROUND

Metal matrix composite materials may include a metal matrix phase and a particle phase. The particle phase may include particles formed of materials designed to enhance overall material properties of the formed part, for example, by providing increased strength or hardness. Additionally, particles may themselves provide material properties to the formed part that are advantageous.

Particles may be added directly to a molten metal matrix material, and then formed into a composite part, such as in a high-pressure die casting operation. However, it is generally difficult to control the distribution of particles in the formed part. For example, during a casting process, particles added to the molten metal matrix material may accumulate due to mutual attraction in certain areas of the mold, causing undesirable accumulations of particles in certain areas of the formed part. Additionally, particles in the base metal matrix material are typically pushed by a moving solid-liquid interface as a molten part solidifies. As parts formed in high-pressure die casting operations tend to solidify at an outer surface region first, with the solid-liquid interface moving toward an interior of the part as the part solidifies, particles may accumulate within an interior portion of the formed part. As a result, the advantageous material properties associated with the particles are not uniformly distributed in the formed part and, at a minimum, particle placement in the formed part is difficult to control.

Accordingly, there is a need for a composite part, particularly a metal matrix composite part and a method of making the same that addresses the above shortcomings.

### SUMMARY

According to one aspect, there is provided a composite part, comprising: a composite metal material having a metal matrix phase and a particle phase dispersed in the metal matrix phase; an interior region; and an exterior region at least partially surrounding the interior region, wherein an average concentration of the particle phase in the composite metal material is higher in the exterior region than in the interior region.

According to another aspect, there is provided a tooling system for casting a composite part, comprising: a die mold having an interior surface, at least a portion of the die mold interior surface is coated with particles from a particle phase; and an injector configured to inject molten material into the die mold, the molten material includes a metal matrix phase; wherein the die mold is configured to solidify the molten material into the composite part and the die mold interior surface that is coated with particles from the particle phase is configured to distribute the particles in an exterior region of the composite part that at least partially surrounds an interior region of the composite part.

According to another aspect, there is provided a method of casting a composite part in a tooling system having a die mold, the method may comprise the steps of: coating at least a portion of an interior surface of the die mold with a particle phase having a plurality of particles; injecting into the die mold a molten material having a metal matrix phase; and solidifying the molten material within the die mold to form a composite part made of a composite metal material having an exterior region that at least partially surrounds an interior region, wherein an average concentration of the particle phase in the composite metal material is higher in the exterior region than in the interior region.

### DRAWINGS

FIG. 1A is a perspective view of an example composite part in the form of a brake rotor having an interior region largely made up of a metal matrix phase and an exterior region largely made up of both a metal matrix phase and a particle phase;

FIG. 1B is a cross-sectional view of the composite part of FIG. 1A;

FIG. 1C is an enlarged cross-sectional view of the composite part of FIG. 1A;

FIG. 2A is a schematic section view of a tooling system that may be used to form the composite part of FIG. 1A using a high-pressure die casting process;

FIG. 2B is a schematic section view of the tooling in FIG. 2A, where die portions are open during a particle application step;

FIG. 2C is a schematic section view of the tooling in FIG. 2A, where die portions are closed during a molten material loading step;

FIG. 2D is a schematic section view of the tooling in FIG. 2A, where die portions are closed during a first phase of a molten material injection step;

FIG. 2E is a schematic section view of the tooling in FIG. 2A, where die portions are closed at the conclusion of the first phase of the molten material injection step;

FIG. 2F is a schematic section view of the tooling in FIG. 2A, where die portions are closed during a second phase of the molten material injection step;

FIG. 2G is a schematic section view of the tooling in FIG. 2A, where die portions are closed at the conclusion of the second phase of the molten material injection step;

FIG. 2H is a schematic section view of the tooling in FIG. 2A, where die portions are closed during a molten material solidification step;

FIG. 2I is a schematic section view of the tooling in FIG. 2A, where die portions are open during a mold opening step;

FIG. 2J is a schematic section view of the tooling in FIG. 2A, where die portions are open during a part removal step;

FIG. 3 is an enlarged view showing a plurality of particles applied to an interior surface of a die portion, such as the die portions in the tooling of FIG. 2A; and

FIG. 4 is a process flow diagram of an example method for forming a composite part according to a high-pressure die casting process and may be used in conjunction with the tooling of FIG. 2A.

### DESCRIPTION

Exemplary illustrations are provided herein of composite parts (also referred to as metal matrix composite parts or metal matrix parts), that may be formed from composite metal materials, as well as methods and tools for making the same. The composite metal material includes a metal matrix phase and a particle phase. According to one example, the metal matrix phase includes an aluminum-based material where aluminum is the single largest constituent of the material on a weight basis, and the particle phase includes one or more ceramic-based materials where a ceramic is the single largest constituent of the material on a weight basis. The particle phase may be introduced into the metal matrix phase in various ways described further below, thereby producing the composite metal material and facilitating advantageous material properties in the composite part. Examples of methods that may be used to produce a composite part made from a composite metal material having an aluminum-based metal matrix phase and a ceramic-based particle phase include different casting methods, such as high-pressure die casting.

According to one example, a high-pressure die casting method is disclosed that is designed to introduce the particle phase into the metal matrix phase in such a manner that the particles tend to concentrate in an exterior region of the composite part, as opposed to an interior region of the part. By having particles from the particle phase concentrated in the exterior region or outer layer of the composite part, the part may be able to better exhibit some of the material properties provided by the particles, like improved wear resistance, electrical conductivity, thermal conductivity, oxidation resistance, strength, etc. By comparison, in the high-pressure die casting processes noted above, particles that were added directly to a molten base metal before being introduced into a mold would tend to accumulate within interior regions of the composite part due to the tendency, during part solidification, of the molten base metal to cool first along the exterior of the part where the molten material contacts the surface of the mold. In this scenario, particles oftentimes are carried into the interior of the part by the movement of the solid-liquid front towards the part interior. This movement of particles can result in a disproportionate agglomeration or concentration of particles on grain boundaries within the interior of the part, thereby weakening the base metal structure. Moreover, reduced particle concentrations in the exterior region or outer layer of the composite part typically minimizes the impact of the particles' material properties.

In the various examples provided herein, particles from the particle phase are introduced into the composite metal material in a manner that causes them to disproportionately concentrate in the exterior region or outer layer of the composite part, as opposed to the interior region of the part. Examples are also provided where particles from the particle phase are directed or specifically applied to certain portions or sections of the exterior region, such as at high-stress areas of the composite part. Thus, the particle phase may be uniformly distributed across the exterior region of the composite part or it may be non-uniformly distributed such that a concentration of particles is selectively located in local areas of the composite part where certain particle material properties are needed (e.g., particle concentrations in areas where increased wear or corrosion resistance is needed for the composite part).

According to a non-limiting example, one way to concentrate particles from the particle phase in the exterior region of the composite part using a high-pressure die casting method is to first coat an interior surface of a mold with the particles, and then to inject the molten metal matrix phase into the coated mold. As the molten metal matrix phase solidifies within the coated mold or die cavity, an exterior region or outer layer is formed that is particle-rich in comparison to an interior region of the composite part. In this embodiment, the exterior region has a higher concentration of particles than the interior region. Some examples of coating the interior surface of the mold include spraying the particles, rolling the particles, or applying the particles in situ through the use of a thin sheet of particle-laden material, to cite a few possibilities. Other particle application techniques may be used instead.

Examples of tools that can be used to manufacture composite parts, such as the ones described herein, include high-pressure die casting tools having an injector and a mold with at least a portion of an interior mold surface coated with particles. The injector is generally designed to inject or otherwise introduce the molten metal matrix phase into the mold, whereas the mold or die cavity is designed to solidify the composite part into a desired shape. As explained above, coating the interior surface of the mold with particles causes the particle phase to disproportionately concentrate or congregate in the exterior region of the composite part, as opposed to the interior region, thereby imparting certain desirable material properties to the part.

### Composite Part—

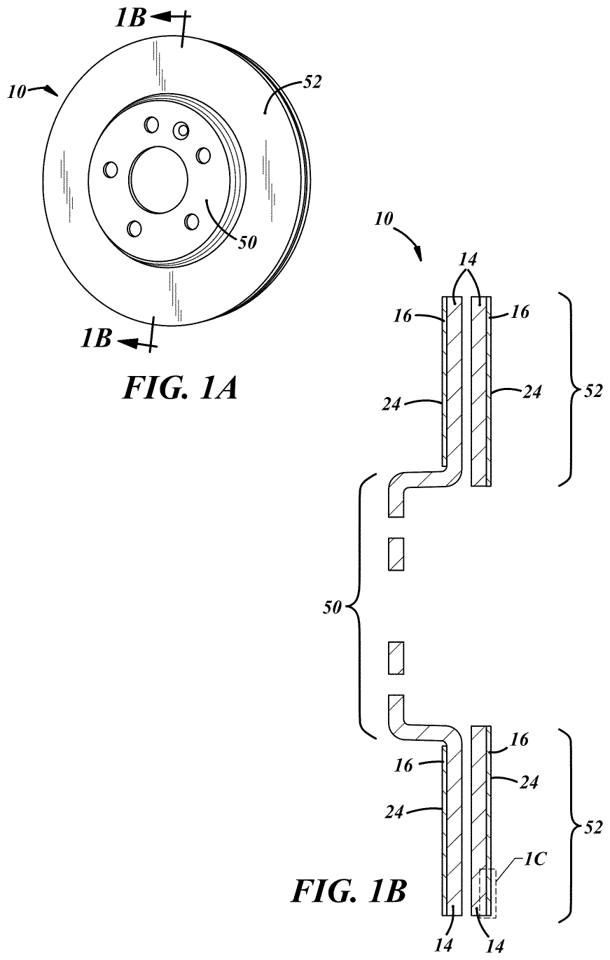

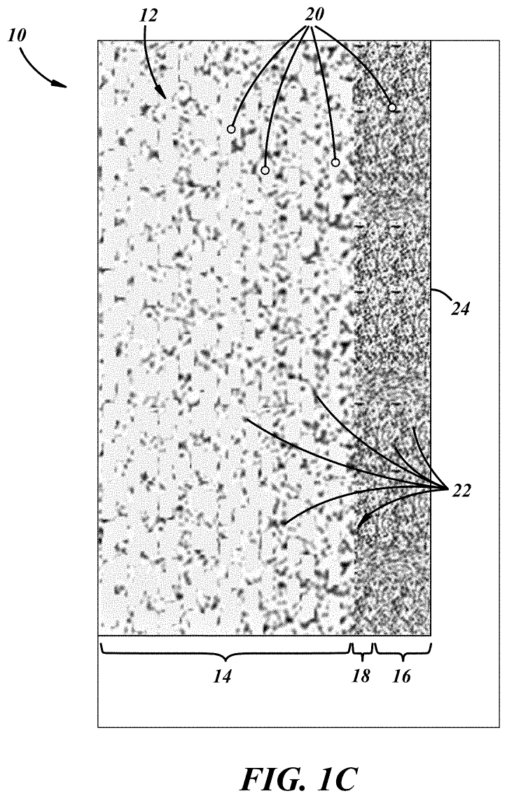

Turning now to FIGS. 1A-1C, an example of a composite part 10 in the form of a vehicle brake rotor is illustrated and discussed in further detail below. It should be appreciated that while a brake rotor is used here as an example of a composite part, the composite part of the present application is not limited to this particular example. For instance, the composite part of the present application may be any type of suitable automotive or non-automotive composite part where certain material properties are needed. Some non-limiting examples of composite parts include vehicle chassis and suspension components, such as wheel hubs, brake calipers, or steering knuckles, as well as vehicle powertrain components such as clutch housings or planetary gear carriers, to cite a few.

The brake rotor or composite part 10 may be formed in a high-pressure die casting operation, such as that described further below, and has a central hub portion 50 and an annular rotor portion 52. The annular rotor portion 52 is generally annular and planar and is configured to be gripped or otherwise frictionally engaged with a brake caliper (not shown) to provide braking force to a vehicle, as is generally known. The annular rotor portion 52 has an interior region 14 and an exterior region or outer layer 16 with an outer surface 24 of the composite part 10.

Turning now to FIG. 1C, an enlarged cross-section of a portion of the composite part 10 is shown. Although the following description is provided in the context of a brake rotor (see FIG. 1C indicator in bottom right section of FIG. 1B), the cross-section could be applicable to any number of other composite parts and is not limited to that specific application. The composite part 10 is made of a composite metal material 12 and may include an interior region 14, an exterior region 16, and a boundary or interface region 18 located between the interior and exterior regions. The composite metal material 12 includes both a metal matrix phase 20 (e.g., one including an aluminum-based material) and a particle phase 22 (e.g., one including a ceramic-based material). As mentioned above, it is preferable that particles from the particle phase 22 be concentrated or disproportionately distributed in the exterior region 16 of the part, as opposed to the interior region 14. While the illustrated interior region 14 includes some particles 22, in some examples the interior region 14 may be substantially free of particles from the particle phase 22, although this is not necessary. Either way, the composite part 10 is made of a composite metal material 12 and includes an interior region 14 and exterior region 16.

The metal matrix phase 20, also referred to as the base metal, typically constitutes a majority of the composite metal material 12 on a weight basis (i.e., typically constitutes more than 50 wt % of the composite metal material), and may include an aluminum-based material, a magnesium-based material, a zinc-based material, or any other metal or metal alloy suitable for casting. In one example of the composite metal material 12, approximately 85-99.9 wt % of the overall material is made up of the metal matrix phase 20, whereas the remainder of the material includes the particle phase 22 and/or other constituents. In other examples, approximately 95-99.9 wt % or even 95-99.5 wt % of the overall material is made up of the metal matrix phase 20, with the remainder including the particle phase and/or other constituents. Some non-limiting metal matrix phase materials include binary alloys, ternary alloys, quaternary alloys, aluminum alloys (e.g., Al—Si), and magnesium alloys (e.g., Mg—Al). In one particular example, the metal matrix phase 20 makes up a majority of the composite metal material 12 on a weight basis and is primarily made from an aluminum-based material that includes 0-25 wt % silicon (Al—Si(0-25 wt %)). As used herein, the term “aluminum-based material” broadly means any material where aluminum is the single largest constituent by weight and may include pure aluminum, as well as aluminum alloys. Merely by way of example, potential aluminum-based materials that may be used with the metal matrix phase 20 include aluminum A380 alloy, A360 alloy, Aural-2 alloy, or ADC12 alloy, to name a few possibilities.

The particle phase 22 is dispersed or distributed in the metal matrix phase 20 and typically constitutes a minority of the composite metal material 12 on a weight basis (i.e., constitutes less than 50 wt % of the composite metal material), and may include a ceramic-based material or any other suitable particulate. In one example of the composite metal material 12, approximately 0.1-15 wt % of the overall material is made up of the particle phase 22, whereas the remainder includes the metal matrix phase 20 and/or other constituents. In other examples, approximately 0.1-5 wt % or even 0.5-5 wt % of the overall material is made up of the particle phase 22, with the remainder including the metal matrix phase and/or other constituents. Of course, in certain thin-walled parts, such as vehicle suspension shock towers, the overall concentration of the particle phase 22 may be relatively higher, as a result of the exterior region 16 constituting a higher overall percentage of the composite part 10. If concentrations of the particle phase 22 substantially exceed 5.0 wt % of the overall material, the effects may not be beneficial. Some non-limiting examples of suitable particle phase materials include ceramic-based materials such as oxides, carbides, borides, nitrides, silicates and graphite. As used herein, the term “ceramic-based material” broadly means any material where a ceramic is the single largest constituent by weight and may include a ceramic by itself or a ceramic and some other constituent. Merely by way of example, the particle phase 22 may include one or more of the following ceramic-based materials: an oxide (e.g., yttrium oxide (Y₂O₃), magnesium oxide (MgO), aluminum oxide (Al₂O₃), silicon oxide (SiO₂), titanium oxide (TiO₂), zinc-oxide (ZnO2), zirconium oxide (ZrO₂), magnesium aluminum oxide (MgAl₂O₄)); a carbide (e.g., titanium carbide (TiC), silicon carbide (SiC), tungsten carbide (WC)); a boride (e.g., titanium boride (TiB₂)); a nitride (e.g., silicon nitride (Si₃N₄), aluminum nitride (AlN), boron nitride (BN)); a silicate; etc. The particle phase 22 may also include one or more of the following materials: a hydride (e.g., titanium hydride (TiH2)); a metal (e.g., chromium (Cr 526), nickel (Ni), copper (Cu), zinc (Zn), silver (Ag), gold (Au), titanium (Ti)); diamond; graphite, carbon black or carbon nanotubes; fullerene; or some type of inteitiietallic compound such as NiAl or Al₃Ti. The preceding examples only represent some of the possibilities. The particles of the particle phase 22 may have any size that is suitable for their application but, according to one example, they have an average size of between 1 μm and 100 μm, inclusive, and in a more detailed example they have an average size between 20 μm and 50 μm, inclusive. Other particle sizes are possible.

Skilled artisans will appreciate that there are a number of criteria or properties to be considered when selecting a composition for the particle phase 22, including the particles' ability to resist wear and tear, strengthen the part, improve electrical and/or thermal conductivity, provide corrosion resistance, create a protective coating, exhibit magnetic properties, etc. For instance, the composite part 10 may be formed from a composite metal material 12 that includes a metal matrix phase 20 with an aluminum-based material and a particle phase 22 with aluminum-titanium (Al₃Ti) particles. Mixing and solidifying of the metal matrix and particles phases 20, 22 may result in an aluminum-titanium-based nano- or micro-composite material (e.g., Al—Al₃Ti) with improved mechanical behavior at high temperatures. In another example, the particle phase 22 may include titanium-based particles such as TiAl, nickel-based particles such as NiAl and/or metal matrix nano-composite (MMNC) materials, which exhibit reduced fracture toughness and relatively higher hardness than typical aluminum-based metallic materials. It is also possible for the particle phase 22 to include magnetic particles, such as magnetic cobalt nanoparticles provided inside copper grains, to obtain giant magnetoresistive (GMR) materials.

In one particularly useful example, the particle phase 22 may include aluminum oxide (Al₂O₃) or Alumina micro-particles, which may facilitate particle refinement and increased hardness, tensile strength and wear resistance of aluminum-based metal matrix alloys employed as the metal matrix phase 20. Titanium oxides or carbides may be similarly beneficial when used as particle phase 22 in a metal matrix phase 20.

The particle phase 22 may provide material characteristics or properties that are separate and distinct from the metal matrix phase 20 or it may provide ones that interact with the metal matrix phase in a complementary or synergistic fashion. Merely as an example, a corrosion-resistant particle phase 22 may interact with a compatible metal matrix phase 20 in order to increase corrosion resistance of the formed composite part 10, or at least a region of the formed part where the particles are present or concentrated. In another example, an electrically conductive particle phase 22 may interact with a compatible metal matrix phase 20 so as to influence the electrical conductivity of the formed part. Similarly, a magnetic particle phase 22 may cooperate with a suitable metal matrix phase 20 to increase the magnetism of the metallic part, especially where the metal matrix phase or base metal 20 is largely non-magnetic, such as with aluminum-based materials. Other cooperative or synergistic relationships between the metal matrix and particle phases 20, 22 are certainly possible.

In the example illustrated in FIGS. 1A-1C, where a brake rotor is the composite part 10, the particle phase 22 may provide increased wear resistance to the part 10. More specifically, by having a disproportionately high concentration of particles from the particle phase 22 in the exterior region 16 of the annular rotor portion 52, which is a portion of the brake rotor frictionally contacted by a brake caliper, the surface 24 may exhibit increased wear resistance when compared to a similar brake rotor lacking such particle concentrations in this region. In the preceding example, the wear-resistant particles 22 may include ceramic-based materials, such as those described above.

The interior region 14 of the composite part 10 generally acts as the core or structural foundation of the part and is at least partially surrounded by the exterior and/or boundary regions 16, 18. The grain structure of the composite metal material 12 in the interior region 14 may typically be distinct from a grain structure in the exterior region 16. For example, where the part is formed in a high-pressure die casting operation, grains generally tend to be smaller in size in the exterior region 16, leading to some greater mechanical properties in this region, such as strength. By contrast, grain structures in the interior region 14 may be somewhat larger than that of the exterior region 16, as a result of the tendency of the part 10 to cool first along the exterior surface, with the interior region 14 generally cooling less rapidly. The specific material properties of the interior region 14, like the grain structure or density, may vary widely depending on the composition of the composite metal material 12 and/or the manufacturing process used to cast or otherwise form the part. The interior region 14 may be solid or hollow; it may be formed around a separate structural insert within the part or not; it may have a substantially uniform or homogeneous grain structure or not; or it may have any number of different material properties, to cite a few possibilities. According to one embodiment, the interior region 14 includes a composite metal material 12 that, in this region, is substantially comprised of a metal matrix phase 20 made of an aluminum-based material, and does not include many particles from the particle phase 22. In one example, the interior region 14 is “substantially particle-free,” which means that less than approximately 0.5 wt % of the overall composite metal material in the interior region 14 is the particle phase 22, after formation of the part 10. As mentioned above, the exact composition and/or metallurgical structure of the interior region 14 and/or exterior region 16 may vary from the examples given above.

The exterior region 16 at least partially surrounds the interior and/or boundary regions 14, 18 and acts as an outer layer of the composite part 10. By providing a particle-rich exterior region 16, the composite part 10 may be imparted with certain desirable properties or attributes that can make the part particularly well suited for certain applications or uses. The thickness or relative thickness of the exterior region 16 can vary between parts or even within a single composite part, but according to one non-limiting example, the exterior region 16 has a thickness of approximately 0.01-1.0 mm, inclusive. The exterior region 16 may have a generally uniform thickness or a varying thickness; it may have a substantially uniform or homogeneous grain structure or a varying grain structure; it may have a generally uniform or homogeneous distribution or concentration of particles or a varying distribution; and it may have any number of different material properties, to cite a few possibilities. According to one embodiment, the exterior region 16 includes a composite metal material 12 that, in this region, is substantially comprised of a metal matrix phase 20 made of an aluminum-based material, and includes a disproportionate amount of particles from the particle phase 22. In one example, the exterior region 16 is “particle-rich,” which means that more than approximately 5 wt % of the overall composite metal material in the exterior region 16 is the particle phase 22, after formation of the part 10. According to one embodiment, the exterior region 16 includes a composite metal material 12 that, in this region, is primarily comprised of a metal matrix phase 20 made of an aluminum-based material (e.g., approximately 75-95 wt % of the overall composite metal material 12 in the exterior region 16 is the metal matrix phase 20), but has a rather high concentration of particles from the particle phase 22 (e.g., approximately 5-25 wt % of the overall composite metal material 12 in the exterior region 16 is the particle phase 22). In other examples of a particle-rich region, an even higher concentration of the particle phase 22 may be present. Merely by way of example, in some example approaches over 90 wt % of the overall composite metal material in the exterior region 16 is the particle phase 22, and in some cases close to 100 wt % of the overall metal material in the exterior region 16 is the particle phase. The concentration of particles within the exterior region 16 may follow a gradient type distribution where the concentration is highest out towards the outer surface of the composite part 10 and decreases further towards the center and deeper sections of the composite part. In one example, at least 75% of the total amount of particles from the particle phase 22 are located in the exterior region 16 of the composite part 10; in another example, at least 90% of the total amount of particles are located in the exterior region.

The boundary region 18 is at least partially located between the interior and exterior regions 14, 16 and can act as an interface or junction of sorts between those two regions. According to one example, the boundary region 18 is located between an exterior region 16 that includes at least 50% more particles from a particle phase 22, on average, than a corresponding interior region 14. The thickness of the boundary region 18 may vary, depending on a whole host of factors, but according to one example, it has a thickness of approximately 0.001-0.1 mm, inclusive, and is largely comprised of an intermetallic material that includes constituents from both the interior and exterior regions 14, 16. In the case of a metal matrix phase 20 primarily made up of an aluminum-based material and a particle phase 22 primarily having a ceramic-based particulate, the boundary region 18 will substantially be made up of the aluminum-based material. While the grain size of the boundary region 18 may be distinct from that of the interior region 14 and exterior region 16, chemical composition of the boundary region 18 may vary little with respect to the interior region 14.

Particle concentration in the exterior region 16 may allow certain properties to be amplified or increased for specific areas of the composite part 10. The following examples represent some of the potential material property and/or other advantages that can result from a composite part 10 having an interior region 14 at least partially surrounded by a particle-rich exterior region 16:
improved hardness, mechanical strength, wear resistance, creep behavior, and damping properties, for example as may be useful for a composite part 10 having high-wear or high-friction surfaces, such as the brake rotor described herein, or a planetary gear carrier, merely as examples;
improved load-transfer or load-bearing properties;
mismatch of coefficient of thermal expansion (CTE) and elastic modulus (EM) properties between the metal matrix and particle phases may facilitate creation of dislocation networks around the particles;
increased Orowan strengthening, Zener pinning, etc. due to the capability of nanoparticles to act as obstacles to a dislocation movement;
increased work hardening or strain hardening or cold working effects (e.g., plastic deformation of the metallic material may lead to dislocation multiplication and development of dislocation substructures);
increased solid-solution hardening (e.g., the type that can be obtained by adding interstitial or substitutional atoms in the crystal lattice which are responsible for the deformation of the lattice itself and for the formation of internal stresses);
improved precipitation hardening or age hardening (e.g., the type that can rely on changes in solid solubility with temperature to produce fine precipitates which impede the movement of dislocations, or defects in a crystal lattice; dislocations can cross the particles by cutting them or they can bow around them by the Orowan mechanism)
increased Hall-Petch or grain boundary strengthening, which is related to the grain size of the metal matrix phase (e.g., the use of nanoparticles may improve matrix grain refinement).

The exemplary parts, tools, methods, etc. described herein may allow better particle distribution in the exterior region 16 or, more specifically, on the exterior surface of the cast part. As the composite metal material 12 solidifies first along the outer regions that are adjacent the mold or die surface, with the liquid-solid front travelling inwardly into the part interior as the part cools and solidifies, particles have a greater tendency to remain in the exterior region or at the outer surface due to the concentration of particles along the die surface initially. As the metal matrix phase or base metal 20 solidifies, viscous drag force is increased, which reduces the escape velocity of the particle phase 22 and counteracts particle interfacial force. While the particle phase 22 may be forced inwardly during solidification of the metal matrix phase 20, the inward travel of the particles is sufficiently limited or curtailed such that many of the particles remain concentrated in the exterior region 16; this is particularly true considering that virtually all of the particles start off in the exterior region. All of the above can help lead to the formation of one or more particle-rich exterior region(s).

### Tooling System—

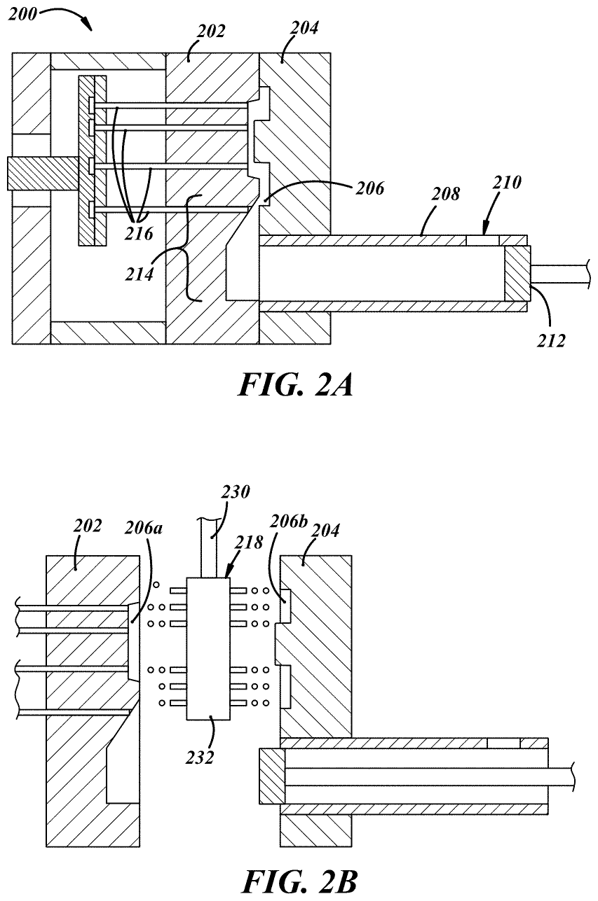

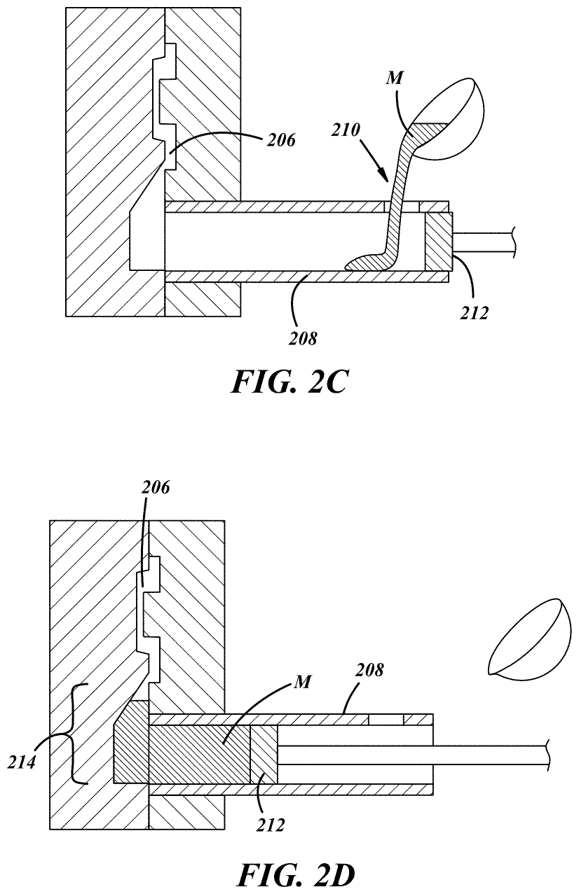

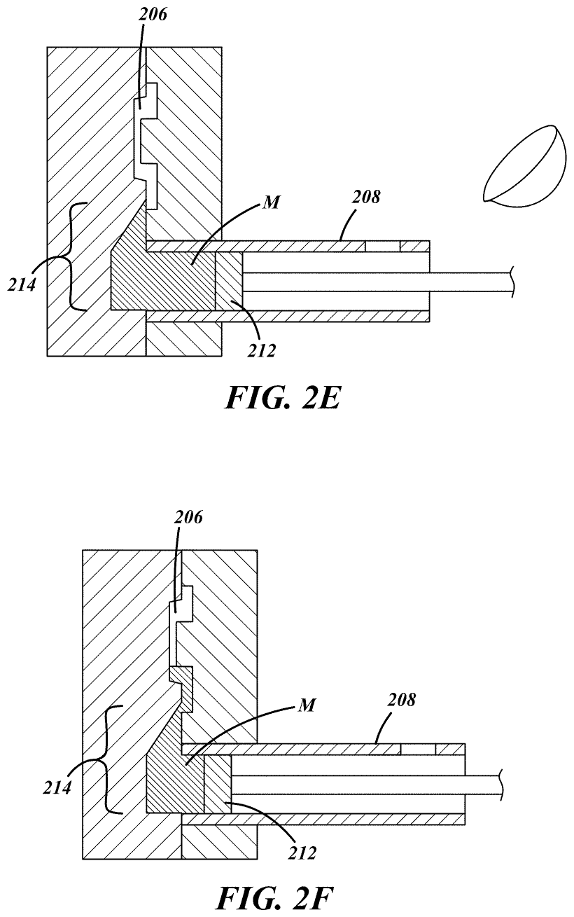

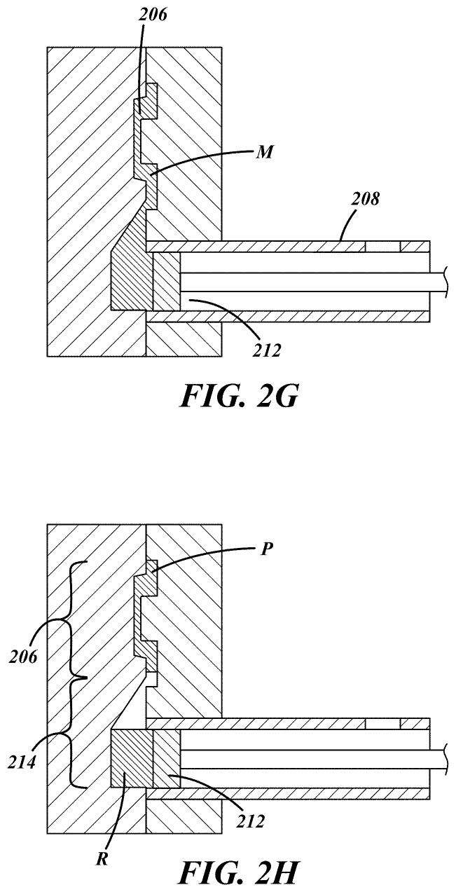

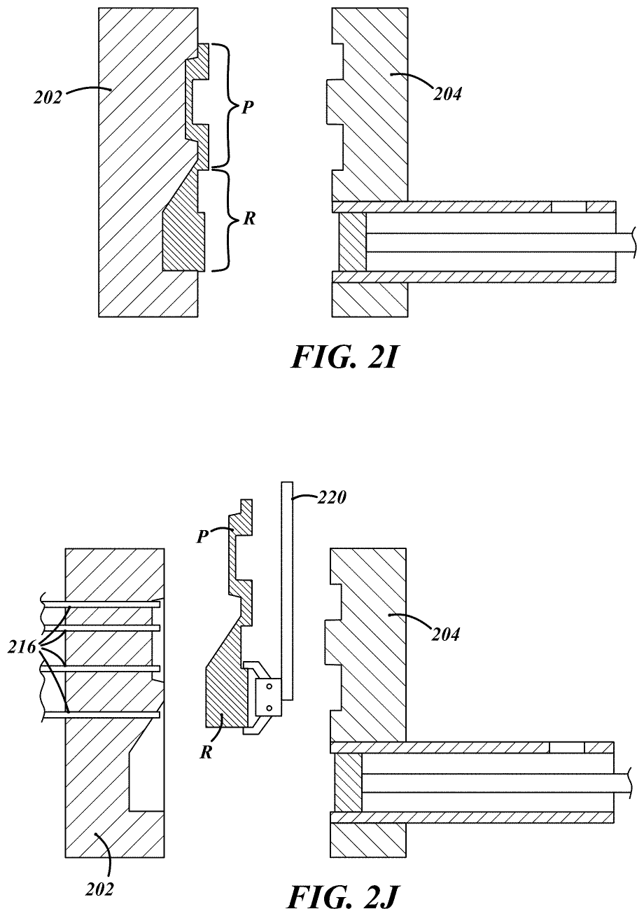

The composite parts described herein may be formed in a casting process, such as a high-pressure die casting process, where the particle phase 22 is applied to an interior surface of a mold before the metal matrix phase 20 is introduced, in molten form, into the mold. Referring now to FIGS. 2A-2J, one example of a tooling system 200 for use in a high-pressure die casting process is illustrated. According to one potential embodiment, the tooling 200 includes die portions 202, 204 that define a mold or die cavity 206, a sleeve 208, a plunger 212, a runner 214, ejector pin(s) 216, a die sprayer 218, as well as any other known equipment needed for such casting operations.

The die portions 202, 204 (shown here as side-by-side, although other arrangements are possible) define an interior mold or die cavity 206 that is in the size and shape of the desired part. One or both of the die portions 202, 204 may be moveable, for example to effect relative movement between the die portions, to facilitate removal of parts formed within the tooling, for service/repair of the tooling, etc. For example, the die portion 202 may be moveable with respect to the other die portion 204, which may be stationary. Alternatively, both die portions 202, 204 may be moveable. The die portions 202, 204 cooperate to define a mold or interior cavity for forming one or more parts.

Molten material (not shown in FIG. 2A) may be injected or otherwise introduced into the mold cavity 206 defined by the die portions 202, 204 by way of the sleeve 208. For example, molten material may be poured into a pour hole 210 and forced into the mold cavity 206 by a plunger 212 as will be described further below. The molten material may then enter the mold cavity 206 by way of the runner 214, which extends from an end of the sleeve 208 to an entrance of the mold cavity 206. In one example, the molten material introduced through the sleeve 208 and the runner 214 includes an aluminum-based material that is part of the metal matrix phase 20, but not particles from the particle phase 22.

One or more cooling channels or other thermal management features (not shown) may be provided in one or both die portions 202, 204 adjacent the mold cavity 206, in the runner 214, and/or in some other part of the tooling 200 to help manage or control the temperature of the molten material during the casting process.

The ejector pins 216 may be provided to facilitate removal of a formed part from the mold cavity 206. Any number and/or type of ejector pin 216 may be provided that is convenient. Some of the best illustrations of the ejector pins 216 are shown in FIGS. 2A, 2B and 2J.

The die sprayer 218, an example of which is illustrated in FIG. 2B, is designed to spray or otherwise apply particles from the particle phase 22 to one or more interior surfaces of the die portions 204, 206. According to this example, the die sprayer 218 may include a robotic or other type of precision controlled arm 230 and a spray head 232. When the die portions 204, 206 are open so that the mold or die cavity 206 is exposed, the arm 230 may move the spray head 232 into position so that particles from the particle phase 22 can be sprayed or otherwise applied to interior surfaces of the die portions. As illustrated in FIG. 2B, the spray head 232 may be configured to apply particles in the regions of the mold interior corresponding to the annular rotor portion 52 of the brake rotor 10.

As noted above, a die sprayer need not be employed, as other types of particle application tools may be used instead. Some examples of such tools may include rolling equipment for rolling the particles onto the interior mold surfaces, thin film placement equipment for positioning particle-laden sheets or mesh in the mold cavity, foaming equipment for providing particle-infused foam into the mold cavity, or any other particle delivery equipment known in the art.

### Method of Producing Composite Part—

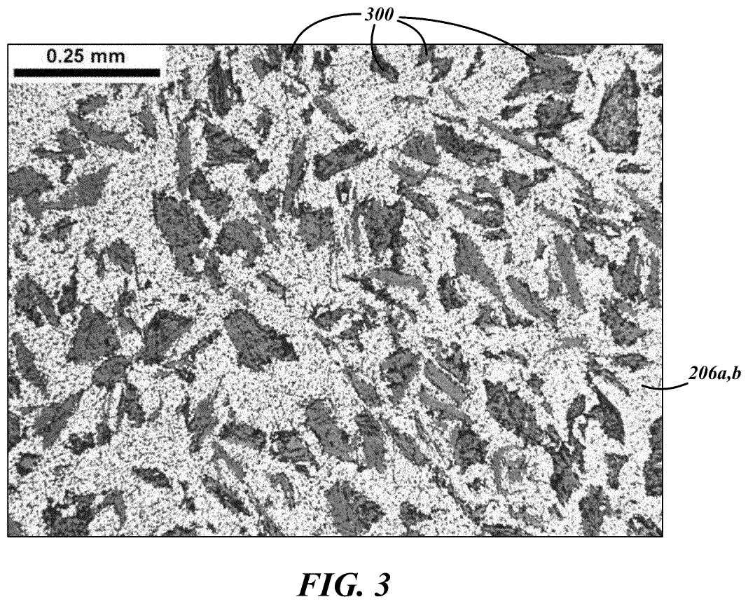

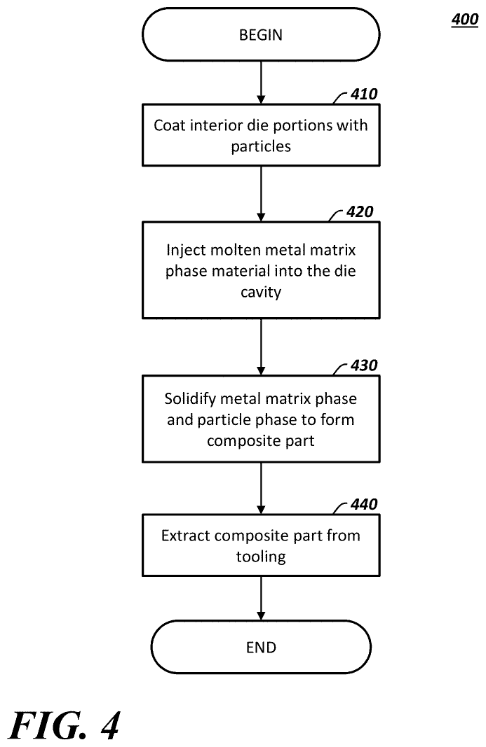

Referring now to FIG. 4, a flowchart of an exemplary casting method 400 for manufacturing a composite part 10 is shown. It is preferable that the casting method be a high-pressure die casting method, such as the type used to cast aluminum-based parts, but this is not necessary. This process is described in conjunction with the tooling drawings of FIGS. 2A-J and the enlarged micrograph of FIG. 3.

Starting with step 410, the method coats or otherwise applies particles to one or more interior surfaces of the die portions 202, 204. As an example, once the die portions 202, 204 are separated or spaced apart, the particles (e.g., those including a ceramic-based material) may be sprayed onto interior surfaces 206a, 206b of the die portions using a die sprayer 218 such that the particles adhere thereto, at least temporarily until the molten metal matrix material 20 is injected. To help facilitate adherence of the particles to the die interior surfaces, the particle phase 22 may further include some type of binder, adhesive, filler, etc. According to one possibility, the particle phase 22 may be in the form of a dry powder that is dispersed or entrained in the die spray as it is being sprayed onto the die interior surfaces. In some examples, the die spray may include a release agent or lubricant, which generally assists in removal of the finished part after solidification. Moreover, such release agents or lubricants may also facilitate the particle phase 22 “sticking” to the die interior surfaces. Die sprays may be applied during air blow-off of the cavity, in between cycles of an injection/molding process, or at some other suitable time.

Alternatively, or in addition to spraying, particles may be applied to the die interior surfaces in a solid material form (e.g., by way of a paste, metallic foil, foam metal, or metal mesh). For instance, particles from the particle phase 22 may be included in a paste that is applied manually or via an automated applicator to a die interior surface or portions thereof. In another example, particles from the particle phase 22 may be included on a foil material or metal mesh that is affixed to the die interior surface or portions thereof. As the molten metal matrix phase material is injected into the mold, the heat of the molten material can melt and disperse the solid foil/foam/mesh material within the exterior region 16 of the part.

The application of particles in step 410 can be over the entire die interior surface or it can be selective so that particles are only applied to portions of the die interior surface where they are most needed. For example, applying particles from the particle phase 22 to an area that includes an undercooled zone of a cast part (e.g., a zone that is part of the exterior region 16, but is adjacent to an outside surface of the casting) may help to reduce the grain size of the metallic material, increase strength, corrosion resistance, and create a protective coating around the cast part. In a different example, particles from the particle phase 22 are targeted or directed to a relatively high-stress region of the part by initially applying the particles to a section of an interior mold surface whose location corresponds to the high-stress area of the part, such as the annular rotor portion 52 of the brake rotor 10 illustrated in FIGS. 1A-1C. Other sections of the interior mold surface may be provided with or without particles (e.g., a first section of the mold surface could be coated with a first type of particle and a second section of the mold surface could be coated with a second type of particle), or the different sections could have different concentrations of the particle phase, to cite several possibilities.

In FIG. 3, there is shown an exemplary micrograph of an interior die surface 206a, 206b having a plurality of particles 300 from a particle phase 22 adhered thereon. Of course, the spacing, density, size, etc. of the particles 300 can vary depending on the application. Once the interior die surfaces 206a, 206b are sufficiently coated with particles, the die sprayer 218 is moved out of the way so that the die portions 202, 204 can close.

In step 420 with the die portions 202, 204 closed, the method then injects molten metal matrix phase material into the die cavity 206. This process is schematically illustrated in FIGS. 2C-2G. With the plunger 212 retracted at an end of the sleeve 208 opposite the mold cavity 206, molten metal matrix phase material M (e.g., an aluminum-based molten material) may be introduced into the sleeve 208 through the pour hole 210; FIG. 2C. Next, the plunger 212 may be advanced in the sleeve 208, thereby forcing the molten material M out of the sleeve 208 and into the runner 214; FIG. 2D. The plunger 212 continues to advance within the sleeve 208, forcing the molten material M through the runner 214 and into the mold cavity 206; FIG. 2E. For example, the plunger 212 may inject the molten material M into the mold cavity 206 according to a two-stage process; in a first stage, the plunger 212 initially moves at a relatively slow speed as the molten material M is pushed out of the sleeve 208 and into the runner 214 (e.g., FIG. 2D); and in a second stage, the plunger 212 moves at a relatively fast speed so as to inject the molten material M through the runner 214 and into the mold cavity 206 with increased pressure or force (FIGS. 2E, 2F). Once the mold cavity 206 is properly filled with molten material M (FIG. 2G), the method may proceed to the solidifying step.

At step 430, the method allows the molten material M to solidify and form the composite part P. The exact process of the solidification step may vary and is dependent on process parameters and other variables. In one embodiment of step 430, the particles from the particle phase 22 (e.g., ceramic-based particles) begin to migrate from the coated interior surfaces 206a, 206b of the die portions 202, 204 into the part. During this process, the particle phase 22 begins to infuse or dissipate within the metal matrix phase 20 (e.g., one having an aluminum-based material) to form the composite metal material 12. For reasons already explained, a majority of the particles from the particle phase 22 may stay within the exterior region 16 of the part during part solidification, thereby forming a particle-rich exterior region or outer layer. During step 430, the particles from the particle phase 22 may melt into or interfuse with the metal matrix phase 20 so that intermetallic or other resulting compounds are formed. To help facilitate solidification, the composite metal material 12 in the mold cavity 206 is cooled (e.g., by way of cooling channels or other cooling features mentioned above). At the completion of step 430, the composite metal material 12 is solidified into a part P (e.g., a brake rotor 10 or some other vehicle component); see FIG. 2H.

The molten material remaining in the runner 214 may solidify thereafter, depending on factors such as the relative size of the runner to the mold cavity 206. If so, the solidified runner material forms a portion R; see FIG. 2I.

Lastly, in step 440, the method extracts the composite part P, R from the tooling. An example of this step is demonstrated in FIGS. 2I and 2J. Once the part P and runner portion R have been substantially solidified, the die portions 202, 204 may be separated or otherwise moved apart, exposing the part P and the runner portion R. The ejector pin(s) 216 may then urge the solidified part P and runner portion R away from the die portion 202, as seen in FIG. 2J, for removal by an extractor arm 220, by manual extraction, or some other suitable part extraction technique. The part P and runner portion R may then be separated, and any additional finishing steps (e.g., machining, grinding, polishing, etc.) may be performed on the part P to remove additional flashing (not shown) or other portions of the composite part P that may be undesirable.

The resulting composite part P includes may include an interior region 14 and an exterior region 16. The interior region 14 is largely comprised of a metal matrix phase 20 (e.g., one having an aluminum-based material), whereas the exterior region 16 is largely comprised of a composite metal material 12 that has particles from a particle phase 22 (e.g., particles made from a ceramic-based material) distributed within the metal matrix phase 20. This configuration, in turn, may produce a composite part with a thin particle-rich exterior region 16 at least partially surrounding a substantially particle-free interior region. It is again worth noting that the particle-rich exterior region 16 or outer layer does not need to extend around the entire outer surface of the composite part; instead, it could just be located or positioned in certain localized areas of the composite part where particle properties are needed.

It is to be understood that the foregoing description is not a definition of the invention, but is a description of one or more exemplary illustrations of the invention. The invention is not limited to the particular example(s) disclosed herein, but rather is defined solely by the claims below. Furthermore, the statements contained in the foregoing description relate to particular exemplary illustrations and are not to be construed as limitations on the scope of the invention or on the definition of terms used in the claims, except where a term or phrase is expressly defined above. Various other examples and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A composite part, comprising:
a composite metal material having a metal matrix phase and a particle phase dispersed in the metal matrix phase;
an interior region; and
an exterior region at least partially surrounding the interior region, wherein an average concentration of the particle phase in the composite metal material is higher in the exterior region than in the interior region.

2. The composite part of claim 1, wherein the metal matrix phase includes at least one of an aluminum-based material or a magnesium-based material.

3. The composite part of claim 2, wherein the metal matrix phase includes an aluminum-based material that includes aluminum and between 0-25 wt % silicon, inclusive.

4. The composite part of claim 1, wherein the particle phase includes a ceramic-based material.

5. The composite part of claim 4, wherein the particle phase includes a ceramic-based material that includes at least one of an oxide, a carbide, a boride, a nitride or a silicate.

6. The composite part of claim 1, wherein the interior region is substantially particle-free such that less than approximately 0.5 wt % of the overall composite metal material in the interior region is the particle phase.

7. The composite part of claim 1, wherein the exterior region is particle-rich such that more than approximately 5 wt % of the overall composite metal material in the exterior region is the particle phase.

8. The composite part of claim 7, wherein the particle phase in the exterior region has a gradient type distribution such that a concentration of particles is highest near an outer surface of the composite part and decreases further towards a center of the composite part.

9. The composite part of claim 7, wherein the particle phase in the exterior region has a non-uniform distribution such that a concentration of particles is selectively located in local areas of the composite part where certain particle material properties are needed.

10. The composite part of claim 1, wherein the composite part further includes a boundary region located at least partially between the interior region and the exterior region, the boundary region has a thickness of approximately 0.001-0.1 mm, inclusive, and is largely comprised of intermetallic materials that include constituents from both the interior region and the exterior region.

11. The composite part of claim 1, wherein the composite part is a brake rotor that includes a central hub portion and an annular rotor portion, the annular rotor portion includes the exterior region such that the higher average concentration of the particle phase in the exterior region increases the wear resistance of the annular rotor portion.

12. A tooling system for casting a composite part, comprising:
a die mold having an interior surface, at least a portion of the die mold interior surface is coated with particles from a particle phase; and
an injector configured to inject molten material into the die mold, the molten material includes a metal matrix phase;
wherein the die mold is configured to solidify the molten material into the composite part and the die mold interior surface that is coated with particles from the particle phase is configured to distribute the particles in an exterior region of the composite part that at least partially surrounds an interior region of the composite part.

13. (canceled)

14. A method of casting a composite part in a tooling system having a die mold, the method comprising the steps of:
coating at least a portion of an interior surface of the die mold with a particle phase having a plurality of particles;
injecting into the die mold a molten material having a metal matrix phase; and
solidifying the molten material within the die mold to form a composite part made of a composite metal material having an exterior region that at least partially surrounds an interior region, wherein an average concentration of the particle phase in the composite metal material is higher in the exterior region than in the interior region.

15. The method of claim 14, wherein the coating step further comprises g spraying the portion of the interior surface of the die mold with the particle phase that includes a ceramic-based material.

16. (canceled)

17. (canceled)

18. (canceled)

19. The method of claim 14, wherein the coating step further comprises selectively coating a first portion of the interior surface of the die mold with the particle phase having a plurality of particles and leaving a second portion of the interior surface of the die mold uncoated, wherein the first portion of the interior surface corresponds to a local area of the composite part where certain particle material properties are needed.

20. The method of claim 14, wherein the coating step further comprises selectively coating a first portion of the interior surface of the die mold with the particle phase having a first concentration of particles and selectively coating a second portion of the interior surface of the die mold with the particle phase having a second concentration of particles, wherein the first concentration of particles is greater than the second concentration of particles.

21. The method of claim 14, wherein the coating step further comprises selectively coating a first portion of the interior surface of the die mold with the particle phase having a first type of particle and selectively coating a second portion of the interior surface of the die mold with the particle phase having a second type of particle, wherein the first type of particle is different than the second type of particle.

22. The method of claim 14, wherein the injecting step further comprises injecting into the die mold the molten material having the metal matrix phase that includes at least one of an aluminum-based material or a magnesium-based material.

23. (canceled)

24. (canceled)

25. The method of claim 14, wherein the solidifying step further comprises solidifying the molten material within the die mold to form the composite part, the solidification results the composite part having a boundary region located at least partially between the interior region and the exterior region, the boundary region has a thickness of approximately 0.001-0.1 mm, inclusive, and is largely comprised of intermetallic materials that include constituents from both the interior region and the exterior region.

26. The method of claim 14, wherein the solidifying step further comprises cooling the molten material within the die mold so that a solid-liquid front carries the particles from the particle phase away from the portion of an interior surface of the die mold and distributes the particles within the exterior region of the composite part.

27. The method of claim 14, wherein the casting method is a high-pressure die casting process.
